(19) United States
(12) Patent Application Publication
(10) Pub. No.: US 2016/0293348 A1
(43) Pub. Date: Oct. 6, 2016

(54) POLYFULLERENES USEFUL AS ELECTRODES FOR HIGH POWER SUPERCAPACITORS

(71) Applicant: THE GOVERNING COUNCIL OF THE UNIVERSITY OF TORONTO, Toronto (CA)

(72) Inventors: Dwight Seferos, Mississauga, Ontario (CA); Tyler Schon, Toronto, Ontario (CA); Paul DiCarmine, Los Angeles, CA (US)

(21) Appl. No.: 15/036,687

(22) PCT Filed: Nov. 14, 2014
(86) PCT No.: PCT/CA2014/051096

§ 371 Date: May 13, 2016

Related U.S. Application Data
(60) Provisional application No. 61/904,687, filed on Nov. 15, 2013.

(51) Int. Cl. H01G 11/36; H01G 11/48; C25D 9/02; H01G 11/28

(52) U.S. Cl. CPC H01G 11/36; H01G 11/28; H01G 11/48; C25D 9/02

(57) ABSTRACT

An electrochemically-polymerized fullerene, or fullerene derivative, homopolymer that can be used as an organic negative electrode for supercapacitors is described.

### FIELD OF THE INVENTION

The present invention relates to fullerene-based materials, to methods for production thereof, and to applications therefor, which may for example, be in energy storage or conversion devices such as supercapacitors (SC).

### BACKGROUND

The design of new electrode materials,^{[1,2]} electrolytes,^{[3-5]} and the optimization of electrode morphology^{[6,7]} are critically important for SC research. The potential (V) at which a SC operates is an important parameter that impacts the energy density (E) and power density (P) (Equations 1, 2):^{[8,9]}

$$\begin{matrix}E = \int \frac{IV ( t ) d t}{v} & ( 1 ) \\ {P}_{ma x} = \frac{{V}_{i}^{2}}{4 {vR}_{s}} & ( 2 )\end{matrix}$$

where I is the discharge current, V(t) is the change in voltage over the time of discharge, dt is the change in time over discharge, v the volume of the electrode material, Vᵢ the initial device voltage, Rₛ the equivalent series resistance, and Pₘₐₓ the maximum power of the device.

For SCs using pseudocapacitive materials, the operating potential is limited to where the electrodes exhibit reversible Faradaic behavior. Using only positive charge-accepting materials for both electrodes, the operating potential is limited; when the device is fully charged, one electrode is charged and the other is discharged and when the device is fully discharged, each electrode is at an intermediately charged state. The consequence is that the full charge in each electrode is never harnessed. A highly attractive configuration is an asymmetric device where both positive and negative charge-accepting pseudocapacitive materials are used as the positive and negative electrodes respectively.

Fullerene C₆₀ has become an important material in organic electronics due to its high electron affinity, three-fold degenerate LUMO, and three-dimensional electron transporting abilities.^{[10,11]} Each C₆₀ molecule can reversibly accept up to five electrons at room temperature making it an excellent candidate as a highly capacitive negative electrode for SCs.^{[12]} Unfortunately, the well-defined localized reductions of pristine C₆₀ give rise to large variations in current as a function of potential, prohibiting its use as a negative pseudocapacitive material. The use of fullerene derivatives that have delocalized charges and broadened reduction waves still remains relatively unexplored in SCs. Egashira et al. reported the use of toluene-insoluble fullerene-soot prepared by pyrolyzing C₆₀ in a symmetric SC with a 2.5 V operating potential. The authors attribute the capacitance to a double-layer charge storage mechanism.^{[13]} Winkler and coworkers prepared a C₆₀-Pd polymer that exhibited either pseudocapacitive behavior or double-layer capacitive behavior depending on the amount of Pd that was incorporated.^{[14]} This material exhibits a high (200 F g⁻¹) capacitance for a single electrode material, however the use of a stoichiometric amount of Pd makes this material impractical for commercial devices.

### SUMMARY

Described here is the first use, known to the inventors, of an electrochemically-polymerized fullerene homopolymer that can be used as an organic negative electrode for SCs. Specifically disclosed is an electrochemically-polymerized fullerene homopolymer using a TBASbF₆ salt as an electrolyte and the resultant polymer's use as an organic negative electrode for SCs. Additionally, an asymmetric SC using PC₆₀ as the negative electrode and PEDOT as the positive electrode is disclosed. The asymmetric device architecture affords high Pₘₐₓ relative to that of the symmetric capacitors constructed using PEDOT or PC₆₀ separately.

Supercapacitors (SCs) are becoming increasingly important for energy storage in electronics and hybrid/electric vehicles because they store a significant amount of energy and have high power. Integrating SCs with batteries in electronic devices can help reduce the size, the time needed for charging, and extend the life of the battery. Pseudocapacitive materials, such as organic conjugated polymers and inorganic metal oxides, are highly attractive for SCs because they store charge both Faradaically and non-Faradaically. Conjugated polymers in particular, due to their low cost, are becoming widely recognized as cheap and highly capacitive replacements for activated carbon SC electrodes. Unfortunately, they are mainly limited to positive charge-accepting materials that are only stable in the neutral or positively charged state. Using only positive charge-accepting polymers limits the operating potential, energy, and power of the device. Here we report a novel electropolymerized C₆₀ fullerene polymer (PC₆₀) with a tetrabutyl ammonium hexafluoroantimonate (TBASbF₆) salt is a highly pseudocapacitive negative charge-accepting material for SCs. A device using PC₆₀ as a negative electrode and a poly(3,4-ethylenedioxythiophene) (PEDOT) positive electrode has a high operating potential (2.2 V), maximum power (4270 kW L⁻¹) and energy density (2.58 Wh L⁻¹ at 0.1 mA cm⁻²). The results described herein highlight the utility of using negative charge-accepting organics for electrochemical energy storage.

An embodiment of the invention is thus a method for preparing a composite material comprising electrically conductive material, the method comprising electrochemically polymerizing a fullerene on a current collector. The fullerene can be e.g., C₆₀ or a higher fullerene such as C₇₀ or C₈₄. In an example described in greater detail below, the fullerene is C₆₀. The deposition/polymerization can be accomplished by electrochemically oxidizing the fullerene in the presence of a tetrabutyl ammonium hexafluoroantimonate (TBASbF₆) salt. The tetrabutyl ammonium can instead be a tetraalkyl ammonium in which the alkyl groups are methyl, ethyl, propyl, isopropyl, butyl, sec-butyl, t-butyl, pentyl, neopentyl, isopentyl, or hexyl, and can be any combination of these alkyl groups.

Oxidizing is conducted using cyclic voltammetry under inert conditions and at ambient temperature in an example described below. The method can further include n-doping the polyfullerene formed on a current collector such that the electrically conductive material displays reversible pseudocapacitive characteristics in the presence of organic electrolytes under standard charging or discharging conditions. Standard charging and discharging conditions relates to the material being charged or discharged between any state of charge under potentiodynamic, galvanostatic, constant power, or any method that places/displaces charge within the material by means of electrical and/or ionic current.

An aspect of the invention is a composite material comprising polyfullerene electrochemically deposited on a substrate. An example of a substrate is a current collector. The polyfullerene can be a branched polymer of C₆₀ or higher fullerene monomeric units i.e., a homopolymer. The polyfullerene can be doped with e.g., TBASbF₆, and a preferred polyfullerene is a homopolymer of C₆₀. The material can be prepared so that the polyfullerene has a thickness of at least 100 nm, or at least 1,000, at least 10,000, at least 20,000, at least 30,000, at least 40,000, at least 50,000, at least 60,000, at least 70,000, at least 80,000, at least 90,000 or at least 100,000 nm, or greater. The material can be prepared such that the polyfullerene has a capacitance of at least 164 F cm⁻³ and stores multiple charges per monomer unit.

In an embodiment, the invention is a supercapacitor cell that has a negative-charge accepting electrode and a positive-charge accepting electrode, each electrode covering a current collector, an electrically insulating membrane separating the electrodes from each other, and an ionic electrolyte in which the electrodes are submerged, wherein the negative-charge accepting electrode comprises an n-doped polyfullerene porous to the electrolyte. The positive-charge accepting electrode can include a p-doped poly(3,4-ethylenedioxythiophene) (PEDOT). As described above, the polyfullerene can be electrochemically deposited on the current collector it covers. The polyfullerene can be a monomer comprising C₆₀ units. The supercapacitor can be prepared such that it achieves a maximum power density of at least 4270 kW L⁻¹ and/or an energy density of at least 2.58 Wh L⁻¹ at 0.1 mA cm⁻².

In an embodiment, the invention is an electrode comprising poly(3,4-ethylenedioxythiophene) (PEDOT) doped with a TBASbF₆ electrolyte.

### DESCRIPTION OF THE DRAWINGS AND TABLES

Embodiments of the present invention are described, by way of example only, with reference to the drawings in which:

FIG. 1 shows a representative oxidative polymerization of C₆₀;

FIG. 2 shows a profilometry trace of PC₆₀;

FIG. 3 shows (a) a top-view and (b) cross-sectional SEM image of the electropolymerized PC₆₀ polymer, (c) a TEM image of the PC₆₀ polymer deposited from an ethanol suspension, (d) an image of the assembled SC with electrical connections and (e) schematic of the assembled SC;

FIG. 4 shows a powder x-ray diffraction pattern of PC₆₀ film electropolymerized onto gold-covered silicon wafer;

FIG. 5 shows (a) Raman spectrum of C₆₀ and PC₆₀, (b) FTIR spectra of C₆₀ (uppermost), TBASbF₆ (middle) and PC₆₀ (lower), (c) and (d) TOF-SIMS spectrum of PC₆₀ (C) from 600 m/z to 800 m/z and (d) 1200 m/z to 1800 m/z. Starred peaks correspond to the monomer and dimer species, (e) a full survey of the XPS spectrum of PC₆₀, and (f) the deconvoluted carbon XPS;

FIG. 6 shows a TOF-SIMS spectrum of PC₆₀;

FIG. 7 shows (a) galvanostatic charge/discharge curves and (b) cyclic voltammograms of the PC₆₀ electrode in a 0.1 M TBASbF₆ acetonitrile electrolyte, (c) capacitance versus current density for PC₆₀ and PEDOT electrodes, (d) complex plane impedance plot of PC₆₀ electrode at various potentials, (e) cyclic voltammogram of the asymmetric PEDOT/PC₆₀ SC at 100 mV s⁻¹, and (f) galvanostatic charge/discharge curve of the asymmetric capacitor at 0.1 mA cm⁻² and 0.5 mA cm⁻²;

FIG. 8 shows a Bode plot of PC₆₀ and of PEDOT at their discharged states;

FIG. 9 shows CV curves of PC₆₀ when cycled up to 250 times at 100 mV s¹;

FIG. 10 shows cyclic voltammograms of PC₆₀ with 0.1 M solutions of different salts in acetonitrile at 100 mV s⁻¹;

FIG. 11 illustrates the stability of PC₆₀ film when cycled in a 0.1 M acetonitrile solution of (a) TBABF₄ and (b) TEABF₄ at 500 mV s⁻¹; and

FIG. 12 shows EIS data of different SC configurations at (a) fully discharged state, (b) half charged state, and (c) fully charged state.

### DETAILED DESCRIPTION

Embodiments of the invention are directed to a polyfullerene electrochemically deposited on a substrate. Fullerenes can be described as spheroidal carbon compounds and are known in the art. For example, the fullerene surface can present [6,6] bonding and [6,5] bonding. The fullerene can have a surface having six-membered and five-membered rings. Fullerenes can be for example C60, C70, or C84, and additional carbon atoms can be added via derivative groups. See for example Hirsch, A.; Brettreich, M., Fullerenes: Chemistry and Reactions, Wiley-VCH Verlag, Weinheim, 2005, which is hereby incorporated by reference.

The fullerene from which a composite material of the invention can be produced can be a “derivatized fullerene”. A “fullerene derivative” can have from 1 to 84, or 1 to 70, or 1 to 60, from 1 to 20, from 1 to 18, from one to ten, or from one to six, or from one to five, or from one to three substituents each covalently bonded to one or two carbons of the fullerene spheroid, the covalently bonding being by [4+2]cycloaddition to at least one derivative moiety, R.

R can be [6,6]-phenyl-C61-butyric acid methyl ester, or the fullerene can be a 1′,1″,4′,4″-Tetrahydro-di[1,4]methanonaphthaleno[1,2:2′,3′,56,60:2″,3″][5,6]fullerene-C61 derivative, Bis(1-[3-(methoxycarbonyl)propyl]-1-phenyl)-[6.6]C₆₂, 1′,4′-Dihydro-naphtho[2′,3′:1,2][5,6]fullerene-C₆₀, (1,2-Methanofullerene C₆₀)-61-carboxylic acid, 3′H-Cyclopropa[8,25][5,6]fullerene-C₇₀-D₅h(6)-3′butanoic acid, 1-(3-Octoxycarbonylpropyl)-1-phenyl-[6.6]C₆₁, C₆₀ Pyrrolidine tris-acid, or C₆₀ Pyrrolidine tris-acid ethyl ester.

As used herein, the terms “about”, and “approximately” when used in conjunction with ranges of dimensions, concentrations, temperatures or other physical or chemical properties or characteristics is meant to cover slight variations that may exist in the upper and lower limits of the ranges of properties/characteristics.

As used herein, the terms “comprises”, “comprising”, “includes” and “including” are to be construed as being inclusive and open ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

### Synthesis

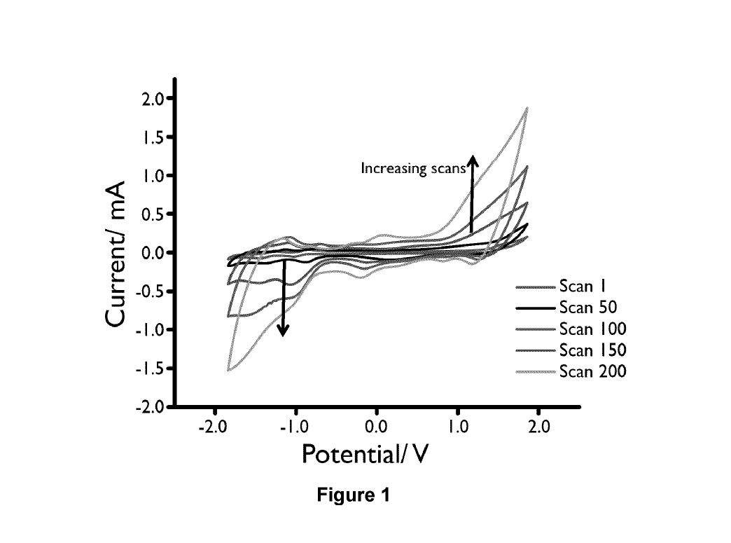

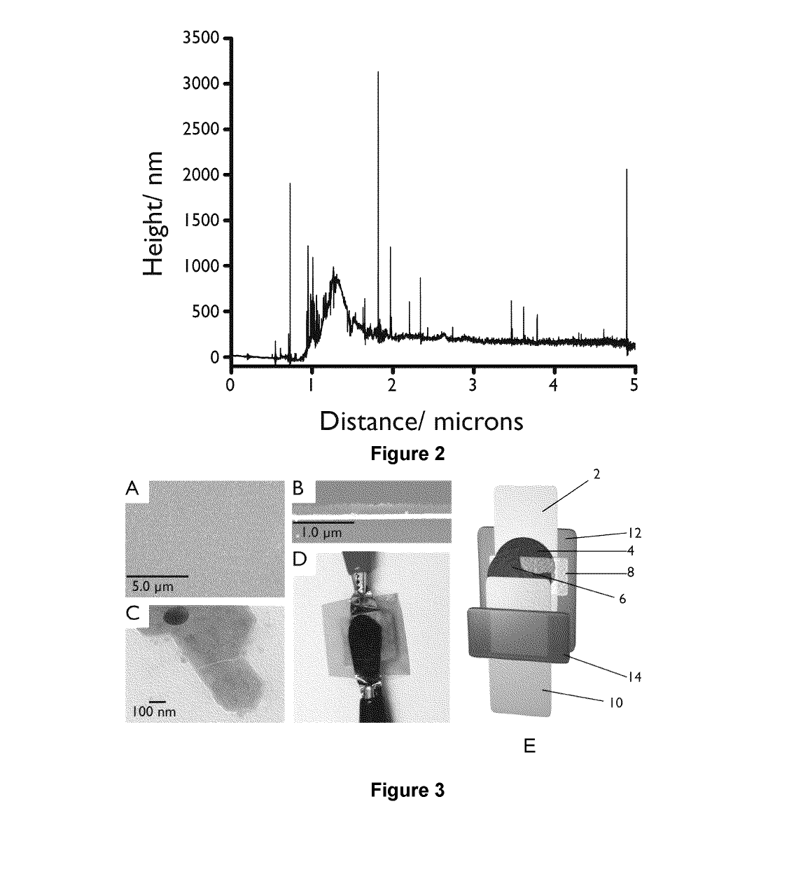

C₆₀ was electropolymerized on gold-coated Kapton™ by cycling the potential from 1.86 V to −1.84 V (versus the ferrocene/ferrocenium redox couple) in dichloromethane containing 0.15 mM C₆₀/0.05 M tetrabutylammonium hexafluoroantimonate (TBASbF₆), adapted from literature procedures.^{[15]} The non-nucleophilic antimony salt component of the polymerization solution was used instead of the previously reported arsenic salt, as it has a reduced toxicity.^{[16,17]} Electrochemical oxidation of C₆₀ avoids the need for binders and deposits the film directly on the current collector. Cycling two hundred times at 400 mV s⁻¹ gave suitably thick films. See FIGS. 1 and 2.

### PC₆₀ Characterization

As there is a large variation in morphology and structure of reported C₆₀ polymers, the film was examined with scanning electron microscopy (SEM) and transmission electron microscopy (TEM). The morphology of the film was found to be similar to other electropolymerized C₆₀ polymers.^{[15,18]} The film has a rough surface due to the presence of small polymer particles. See FIG. 3a. The SEM cross-section of FIG. 3b shows that the film is approximately 170 nm thick, which was confirmed by profilometry, FIG. 2. The film is also porous (FIG. 3c), which is favorable for electrolyte penetration through the entire film during the charging and discharging processes.^{[19]}

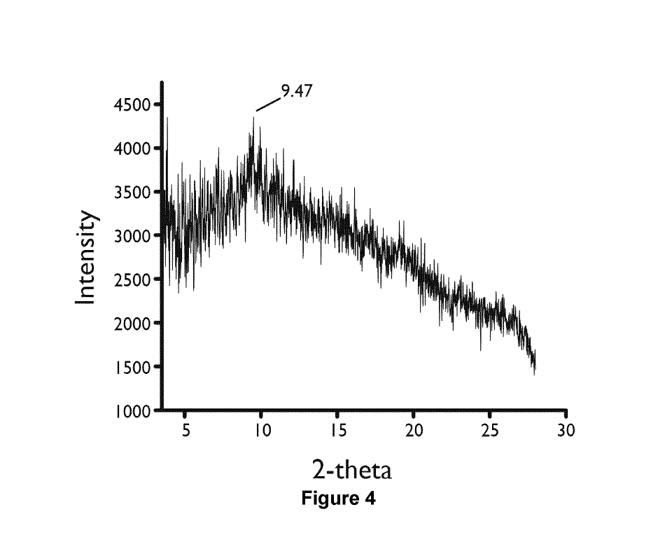

Attempts to characterize the film by powder X-ray diffraction yielded only a small diffraction peak corresponding to a d-spacing of 0.93 nm, consistent with reported C₆₀ polymers joined together by cyclobutane rings,^{[13,14,20-22]} and a large amorphous halo demonstrating that an amorphous polymer was formed (FIG. 4).

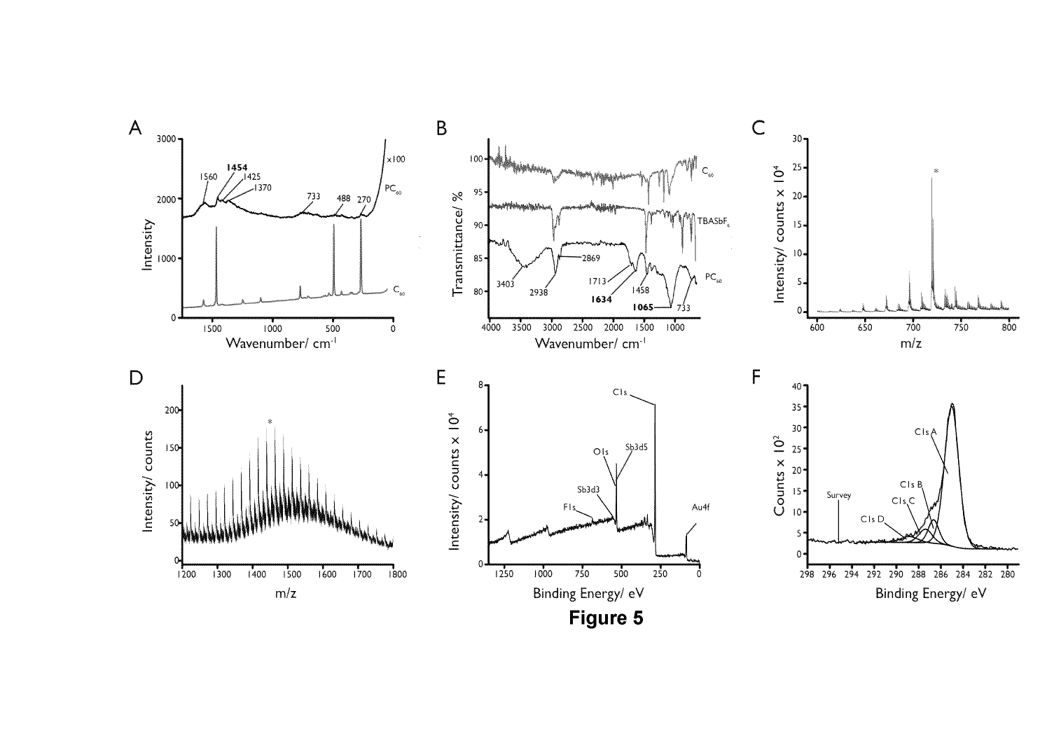

When compared with pristine C₆₀, the Raman spectrum of PC₆₀ was found to contain a number of features that are in agreement with C₆₀ polymers such as a downshift in Raman frequency and lower intensity (FIG. 5a). The Ag(²) mode shifts from 1467 cm⁻¹ to 1454 cm⁻¹ suggesting that the polymer is branched.^{[23]} These results suggest that the bonds connecting the C₆₀ molecules are likely caused by [2+2]cycloaddition reactions between the six-member rings in the C₆₀ monomer, creating the cyclobutane-like linkages.^{[24]}

The Fourier transform infrared (FTIR) spectrum of PC₆₀ is complex compared to C₆₀ or the electrolyte TBASbF₆ (FIG. 5b). The bands attributed to PC₆₀ are located at 1634 and 1065 cm⁻¹ and are likely caused by vibrations associated with the cyclobutane linkages between the C₆₀ cages. The bands at 3403 and 1713 cm⁻¹ are due to adsorbed water^{[15]} and the C—H stretches at 2938 and 2869 cm⁻¹ and peaks located at 1458, 1376, and 733 cm⁻¹ are all attributed to various absorption processes of the supporting electrolyte.

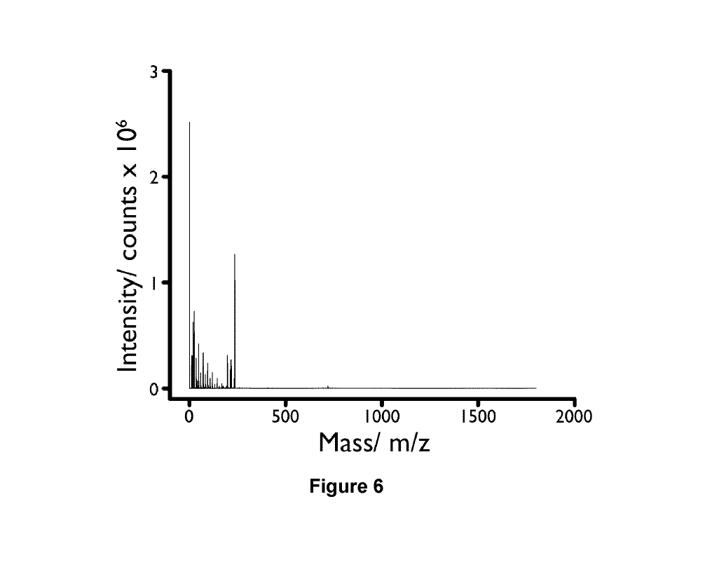

The time-of-flight secondary ion mass spectrum (TOF-SIMS) of PC₆₀ confirms the presence of the electrolyte as well as small C₆₀ fragments (FIG. 6). Large peaks corresponding to C₆₀⁻ (720 m/z) and C_{60±n}⁻ (720±12n m/z) are observed (FIG. 5c). Importantly, higher order C₆₀₊ₙ⁻ species as well as the C₁₂₀ cluster (1440 m/z) are also observed and demonstrate that an addition reaction between the monomers has occurred (FIG. 5d). The lower intensity of the 1200-1800 mass range is due to the instability of the higher order Cₙ species.^{[15]} The mass limit of the instrument prohibits examining larger species (>1800 m/z).

The film contains fluorine, antimony, oxygen, carbon, and gold from the substrate (FIG. 5e) as confirmed by x-ray photoelectron spectroscopy (XPS). The carbon peak is asymmetric (FIG. 5f) due to the presence of carbon atoms in different covalent environments, as well as the presence of ‘shake-up’ features from the highly conjugated C₆₀ cages.^{[1}5,²⁵,2^{6]} The dominant peak (C1s A) is assigned to carbon atoms that are in the C₆₀ cage. The third peak (C1s C) is assigned to the sp³ hybridized carbon atoms that form the cyclobutane rings. The remaining carbon peaks (C1s B, and C1s D) are assigned to the tetrabutyl groups on the ammonium counterion.

### PC₆₀ Electrochemistry

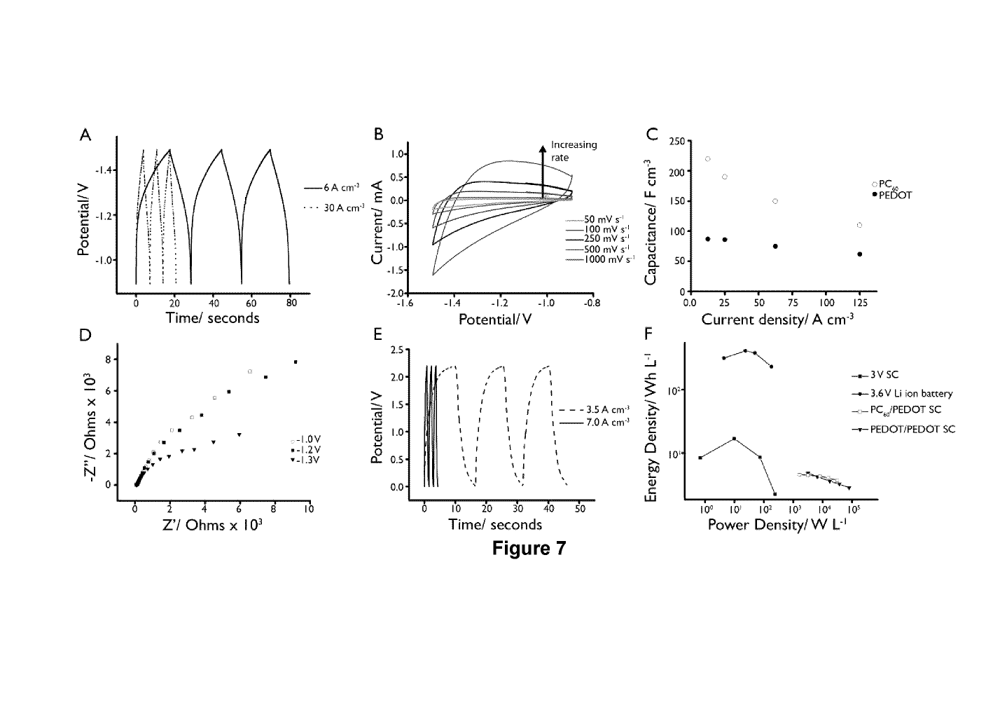

The PC₆₀ electrode exhibits an ideal triangular charge-discharge behavior (FIG. 7a). Having characterized the composition of the PC₆₀ film, electrochemical properties were examined. The film exhibits a pseudo-rectangular cyclic voltammogram for scan rates up to 500 mV s⁻¹ and only deviates at high scan rates of 1 V s⁻¹ (FIG. 7b). The absence of any sharp redox peaks indicates that the charges in PC₆₀ are significantly delocalized. A double-layer type charge storage mechanism may also play a large role in the capacitive behavior.

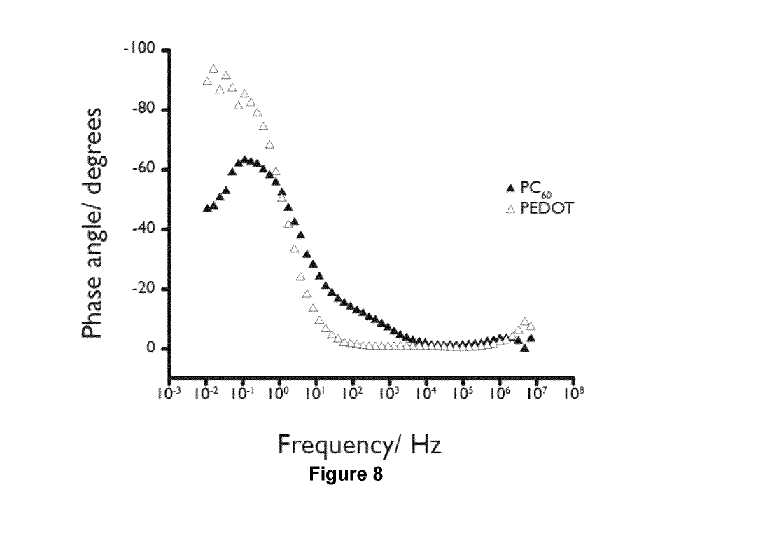

The capacitance (FIG. 7c) of the PC₆₀ electrode ranges from 109-164 F cm⁻³ and decreases with the current density from 0.5 mA cm⁻² (164 F cm⁻³) to 0.1 mA cm⁻² (131 F cm⁻³), likely due to some deterioration of electrode quality. The lower capacitance value at 1.0 mA cm⁻² (109 F cm⁻³) is due to ion diffusion limitations. PC₆₀ has a significantly larger volumetric capacitance than a similarly prepared PEDOT electrode (56.4 F cm⁻³ at 0.5 mA cm⁻²) likely due to the ability of PC₆₀ to accept more electrons per monomer.^{[27]} The impedance of the electrode at different potentials using electrochemical impedance spectroscopy (EIS) (FIG. 7d) was examined. The PC₆₀ electrode exhibits a semicircle at high frequencies, typical of SCs, and an arc shape at low frequencies, deviating from the linear response of ideal SCs. The non-ideal curvature of the line can be explained by the presence of irreversible trap sites that become populated preferentially at low charging potentials.[^{28]} Additionally, the RC time constants were calculated from the Bode plots (FIG. 8). The time constants for PC₆₀ and PEDOT are 473 ms and 661 ms respectively, showing the superior frequency response of the PC₆₀ film.

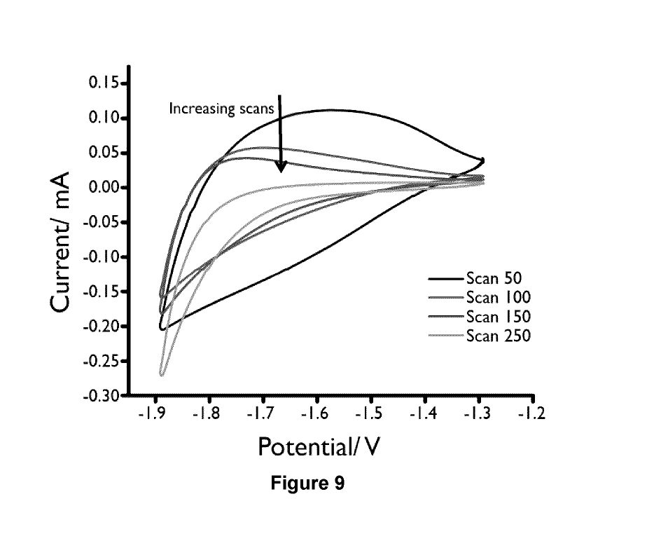

The electrode exhibits slight degradation upon cycling but retains capacitive properties when scanned up to one hundred and fifty cycles (FIG. 9). The electrochemical stability may be improved by using smaller cations in the electrolyte,^{[14,29]} adding carbon nanotubes,^{[30]} or by using solvents such as sulfolane to decrease the amount of charge being trapped.^{[31,32]}

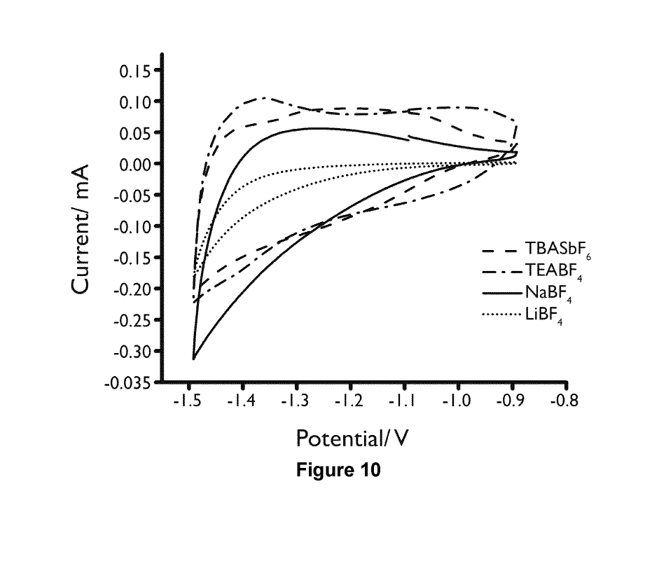

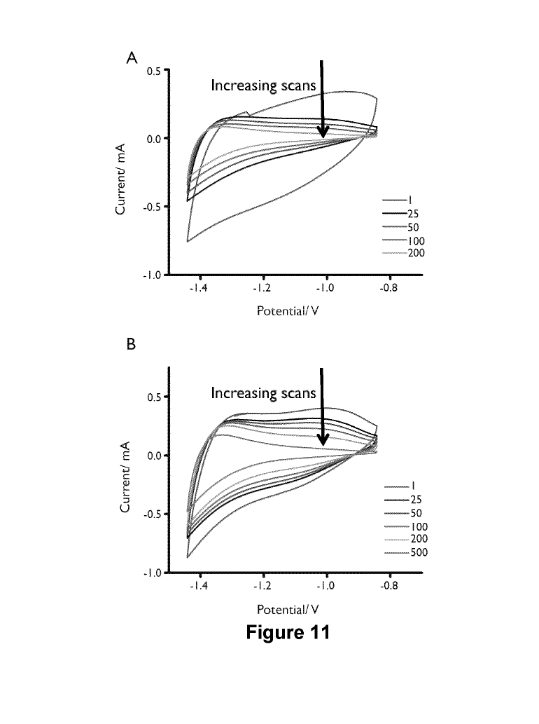

In order to investigate the effects of smaller cations, cyclic voltammetry using the salts TBASbF₆, tetraethyl ammonium tetrafluoroborate (TEABF₄), sodium tetrafluoroborate (NaBF₄) and lithium tetrafluoroborate (LiBF₄) (FIG. 10) was carried out. The shape of the voltammogram is very different between the ammonium and the alkali salts. The ammonium salts allow the charging to be delocalized, broadening the reductions and giving capacitive characteristics. The alkali salts on the other hand on display a strong irreversible reduction. This is attributed to the charges in the polymer film becoming trapped due to the hard nature of the alkali cations. To determine whether the size of the ammonium salt had an effect on stability, cyclic voltammetry was performed on PC₆₀ films with a 0.1 M solution of tetrabutyl ammonium tetrafluoroborate (TBABF₄) and TEABF₄ (FIG. 11). It was observed that while the film using TBABF₄ loses its capacitive characteristics completely after 200 cycles, the film using TEABF₄ degraded after 500 cycles. This demonstrated that by using small soft cations, the stability of the electrode can be increased.

### Asymmetric Device Characterization

A SC with a PEDOT positive electrode and PC₆₀ negative electrode was constructed and used to demonstrate the utility of a PC₆₀ film in an asymmetric SC. Symmetric PEDOT and PC₆₀ SCs were also constructed and used for comparison purposes. The potential range with the most current (1.2-2.2 V) occurs when both PC₆₀ and PEDOT electrodes are operating in their Faradaic potential window (FIG. 7e). The large Faradaic current in the high potential region is favorable since most of the charge delivered occurs at high cell voltages.⁸¹ The charge-discharge behavior of the PEDOT/PC₆₀ SC deviates somewhat from the ideal triangular shape (FIG. 7f, sloped plot in lower right hand side). This is likely due to the mismatch of the electrodes and is present in many other asymmetric configurations found in the literature.^{[1,9,23,33,34]} The symmetric PEDOT/PEDOT SC exhibits the highest capacitance out of the three devices (17.4 F cm⁻³ at 0.1 mA cm⁻²) followed by PEDOT/PC₆₀ (3.83 F cm⁻³) (Table 1). Although the PEDOT/PEDOT SC has almost five times the capacitance of the PEDOT/PC₆₀ SC, the charging takes place over a more narrow potential window. As a result, the energy density of PEDOT/PC₆₀ (2.58 Wh L⁻¹) is comparable to PEDOT/PEDOT (3.47 Wh L⁻¹) due to its extended potential window. The extended potential window gives the PEDOT/PC₆₀ SC almost five times greater Pₘₐₓ than the PEDOT/PEDOT SC (860 kW L⁻¹) achieving an impressive 4270 kW L⁻¹.

TABLE 1
Capacitance, energy density, power density and
equivalent series resistance for assembled SCs

| Current | | Symmetric | Asymmetric |
|---|---|---|---|
| Density | | PEDOT/PEDOT | PEDOT/PC₆₀ |
| (mA cm⁻²) | | device | device |
| 0.1 | Capacitance | 17.4 | 3.83 |
| | (F cm⁻³) | | |
| | Energy Density | 3.47 | 2.58 |
| | (W h L⁻¹) | | |
| 0.5 | Capacitance | 15.0 | 2.33 |
| | (F cm⁻³) | | |
| | Energy Density | 2.99 | 1.56 |
| | (Wh L⁻¹) | | |
| N/A | Equivalent Series | 13.6 | 10.7 |
| | Resistance (Ohms) | | |
| | Maximum Power | 860 | 4270 |
| | Density (kW L⁻¹) | | |

TABLE 2
Capacitance values for individual electrodes

| Current Density | PC₆₀ capacitance | PEDOT capacitance |
|---|---|---|
| (mA cm⁻²) | (F cm⁻³) | (F cm⁻³) |
| 0.1 | 131 | 71.4 |
| 0.2 | 154 | 64.8 |
| 0.5 | 164 | 56.4 |
| 1.0 | 109 | 43.7 |

TABLE 3
Device performance metrics of PC₆₀/PEDOT supercapacitor

| Current | Power Density | Energy Density |
|---|---|---|
| (mA/cm²) | (kW/L) | (Wh/L) |
| 0.1 | 2.07 | 6.65 |
| 0.2 | 4.88 | 4.83 |
| 0.5 | 11.9 | 3.11 |
| 1.0 | 23.1 | 1.87 |

TABLE 4
Device performance metrics of PEDOT/PEDOT supercapacitor

| Current | Power Density | Energy Density |
|---|---|---|
| (mA/cm²) | (kW/L) | (Wh/L) |
| 0.1 | 1.12 | 3.02 |
| 0.2 | 2.28 | 3.00 |
| 0.5 | 5.72 | 2.88 |
| 1.0 | 10.2 | 2.76 |

A C₆₀ polymer was thus electrochemically synthesized and characterized. The C₆₀ monomers are joined together by a cyclobutane ring, forming a branched polymer. The polymer exhibits negative charge-accepting pseudocapacitive behavior, which is suitable for n-type SC materials. Whereas the best known conductive polymers have a charge density below 0.5 per monomer, C₆₀ monomers are able to accept multiple electrons making the material highly capacitive. Asymmetric PC₆₀/PEDOT SCs exhibit comparable energy densities with symmetric PEDOT/PEDOT SCs even though the capacitance of the device is substantially lower. The Pₘₐₓ of the device, however, is greater than four times that of the symmetric PEDOT SC due to a larger operating potential. Overall, this demonstrates the feasibility of using an organic negative charge-accepting material as a negative electrode for SCs.

### EXPERIMENTAL SECTION

### General Considerations

All reagents were used as received unless otherwise noted. Solvents were purchased from Sigma-Aldrich, dried using an Innovative Technology solvent purification system, and stored in an inert N₂ atmosphere glove-box (Innovative Technology). All electrochemical measurements and film synthesis were performed in an inert N₂ atmosphere glove-box using a BioLogic SP-200 Potentiostat/Galvanostat/FRA. All potentials reported for film measurement are referenced to ferrocene. C₆₀ was purchased from Nano-C. All other chemicals were purchased from Sigma-Aldrich.

### Synthesis of TBASbF₆

The preparation of TBASbF₆ was carried out using a modified literature procedure [35]. Briefly, NaSbF₆ (2.6 g, 10 mmol) and tetrabutylammonium bromide (3.3 g, 10 mmol) were dissolved in acetone (10 mL) and stirred at room temperature for 24 hours. The mixture was then filtered to remove the NaBr salt. The solvent was evaporated and the resulting white solid was dissolved in CH₂Cl₂, washed with distilled water three times, dried using MgSO₄, and filtered. The solvent was evaporated, the product was recrystallized twice from ethyl acetate/diethyl ether (1:2), and dried at 125° C. under vacuum for 72 hours.

### Synthesis of PC₆₀ Films

A solution containing C₆₀ (0.15 mM), TBASbF₆ (0.05 M) and CH₂Cl₂ was placed in a custom-made Teflon electrochemical cell sealed with a Viton® O-ring and cycled from 1.86 to −1.84 V using a three-electrode configuration. A gold-coated Kapton™ foil (Astral Technology Unlimited) or a gold-coated silicon wafer (Platypus Technologies) with a surface area of 0.636 cm² was used as the working electrode, a platinum wire was used as the counter electrode and a silver wire was used as a pseudoreference electrode. After 200 CV cycles the film was rinsed three times with clean CH₂Cl₂ and left in the glove-box for further electrochemical characterization.

### Synthesis of PEDOT Films

A solution containing 3,4-ethylenedioxythiophene (EDOT) (7.5 mM), TBASbF₆ (0.05 M) and CH₂Cl₂ was placed in a custom-made Teflon electrochemical cell sealed with a Viton® O-ring. The solution was held at 0.9 V until a charge of 18 mC was collected. The film was rinsed three times with clean CH₂Cl₂ and left in the glove-box for further characterization.

### Material Characterization

The morphology of the films was examined using SEM (Hitachi S-5200 SEM) and TEM (Hitachi H-7000 TEM). Powder X-ray diffraction was performed using a Bruker AXS SAXS NanoStar diffractometer. Raman spectroscopy was carried out on a Thermo Scientific DXR Raman microscope with a 780 nm excitation laser. For PC₆₀, a fluorescence correction was applied to eliminate the fluorescent background. FTIR was performed on a Perkin Elmer Spectrum 100 FT-IR spectrometer equipped with a 10-bounce diamond/ZnSe ATR accessory. XPS was carried out using a Thermo Scientific K-Alpha spectrometer with a monochromated Al K_{α} source. For low-resolution experiments the pass energy was 200 eV and for high-resolution experiments the pass energy was 25 eV. Binding energies were calibrated to place Au4f7/2 at 84.0 eV. TOF-SIMS was performed on an ION-TOF TOF-SIMS IV spectrometer using a Bi₃ ion source in negative polarity mode. Profilometry was performed on a KLA-Tencor P16+ profilometer using a force setting of 0.5 mg and a scanning length of 5 microns.

### Electrochemical Characterization of Films

All electrochemistry experiments on the as synthesized films were performed in a custom made Teflon cell using a 0.1 M TBASbF₆/acetonitrile electrolyte with a platinum wire counter electrode and a silver wire pseudoreference electrode. The capacitance of the film was calculated using C=2E/V² where C is the capacitance and Ewas calculated from the charge/discharge curves using equation 1.

### Device Fabrication and Characterization

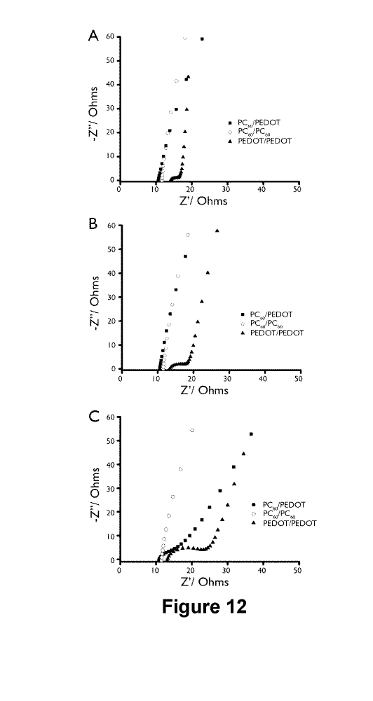

To fabricate a device, each electrode was held at a specific potential (−0.19 V and −0.79 V for PEDOT and PC₆₀ respectively in PEDOT/PC₆₀ device, 0.31 V for PEDOT in PEDOT/PEDOT device, and −1.29 V for PC₆₀ in PC₆₀/PC₆₀ device) for 45 seconds in a 0.1 M TBASbF₆/acetonitrile electrolyte. The electrolyte was removed, the Teflon cells were disassembled and the gold-coated Kapton™ foils were trimmed to minimize the amount of bare gold in the device. Each electrode was placed on silicone adhesive tape with the polymer side facing away from the tape. A 0.1 M TBASbF₆/acetonitrile/15 wt % poly(methyl methacrylate) electrolyte was smeared on the polymer films and a Kimwipe separator soaked in 0.1 M TBASbF₆/acetonitrile was place on one electrode. The two electrodes were brought together (rotated 180 degrees relative to one another) with the polymer films overlapping as shown in FIG. 3d and FIG. 3e. The schematic of the electrodes in FIG. 3e shows the first current collector (Au-Kapton™) 2 having PC₆₀ 4 coated thereon, PEDOT 6, separator/electrolyte 8, second current collector (Au-Kapton™) 10, and first and second silicone tapes 12, 14, respectively. The Rₛ of the devices were calculated from the average Z′ intercept at different states of charge (FIG. 12).

The foregoing description of the preferred embodiments of the invention has been presented to illustrate the principles of the invention and not to limit the invention to the particular embodiment illustrated. It is intended that the scope of the invention be defined by all of the embodiments encompassed within the following claims.

### REFERENCES

[1]H. B. Li, M. H. Yu, F. X. Wang, P. Liu, Y. Liang, J. Xiao, C. X. Wang, Y. X. Tong, G. W. Yang, Nat. Commun. 2013, 4, 1894-7.
[2]J. D. Stenger-Smith, W. W. Lai, D. J. Irvin, G. R. Yandek, J. A. Irvin, J. Power Sources 2012, 220, 236-242.
[3]Y. Shilina, M. D. Levi, V. Dargel, D. Aurbach, S. Zavorine, D. Nucciarone, M. Humeniuk, I. C. Halalay, J. Electrochem. Soc. 2013, 160, A629-A635.
[4]H. Gao, K. Lian, J. Power Sources 2011, 196, 8855-8857.
[5]J. Zhou, Y. Yin, A. N. Mansour, X. Zhou, Electrochem. Solid-State Lett. 2011, 14, A25.
[6]Z. Yu, B. Duong, D. Abbitt, J. Thomas, Adv. Mater. 2013, 25, 3302-3306.
[7]R. Liu, S. B. Lee, J. Am. Chem. Soc. 2008, 130, 2942-2943.
[8]B. E. Conway, Electrochemical Supercapacitors: Scientific Fundamentals and Technological Applications, Kluwer Academic/Plenum Publishers, New York, N.Y., 1999.
[9]C. Zhou, Y. Zhang, Y. Li, J. Liu, Nano Lett. 2013, 1-8.
[10]K. M. Kadish, F. D'Souza, Handbook of Carbon Nano Materials (in 2 Volumes)—Volume 3: Medicinal and Bio-Related Applications; Volume4: Materials and Fundamental Applications, World Scientific, 2012.
[11]L. Echegoyen, L. E. Echegoyen, Acc. Chem. Res. 1998, 31, 593-601.
[12]Q. Xie, E. Pérez-Cordero, L. Echegoyen, J. Am. Chem. Soc. 1992, 114, 3978-3980.
[13]M. Egashira, S. Okada, Y. Korai, J.-I. Yamaki, I. Mochida, J. Power Sources 2005, 148, 116-120.
[14]K. Winkler, E. Grodzka, F. D'Souza, A. L. Balch, J. Electrochem. Soc. 2007, 154, K1.
[15]C. Bruno, M. Marcaccio, D. Paolucci, C. Castellarin-Cudia, A. Goldoni, A. V. Streletskii, T. Drewello, S. Barison, A. Venturini, F. Zerbetto, F. Paolucci, J. Am. Chem. Soc. 2008, 130, 3788-3796.
[16]E. Dopp, L. M. Hartmann, A. M. Florea, A. W. Rettenmeier, A. V. Hirner, Crit. Rev. Toxicol. 2004, 34, 301-333.
[17]S. C. Wilson, P. V. Lockwood, P. M. Ashley, M. Tighe, Environ. Pollut. 2010, 158, 1169-1181.
[18]P. Pieta, G. Z. Zukowska, S. K. Das, F. D'Souza, A. Petr, L. Dunsch, W. Kutner, J. Phys. Chem. C 2010, 114, 8150-8160.
[19]I. E. Rauda, V. Augustyn, B. Dunn, S. H. Tolbert, Acc. Chem. Res. 2013, 46, 1113-1124.
[20]S. Margadonna, D. Pontiroli, M. Belli, T. Shiroka, M. Riccó, M. Brunelli, J. Am. Chem. Soc. 2004, 126, 15032-15033.
[21]A. M. Rao, Eklund, P. C., J. L. Hodeau, L. Marques, M. Nú\ddot{n}ez-Regueiro, Phys. Rev. B 1997, 55, 4766-4773.
[22]M. Nú\ddot{n}ez-Regueiro, L. Marques, J. L. Hodeau, O. Béthoux, M. Perroux, Phys. Rev. Lett. 1995, 278-281, 74.
[23]T. Wågberg, P. Jacobsson, B. Sundqvist, Phys. Rev. B 1999, 60, 4535-4538.
[24]S. G. Stepanian, V. A. Karachevtsev, A. M. Plokhotnichenko, L. Adamowicz, A. M. Rao, J. Phys. Chem. B 2006, 110, 15769-15775.
[25]D. Briggs, Surface Analysis of Polymers by XPS and Static SIMS, Cambridge University Press, Cambridge, U.K., 1998.
[26]M. Ramm, M. Ata, T. Gross, W. Unger, Appl. Phys. A 2000, 70, 387-390.
[27]G. A. Snook, P. Kao, A. S. Best, J. Power Sources 2011, 196, 1-12.
[28]M. D. Levi, Y. Gofer, D. Aurbach, A. Berlin, Electrochim. Acta 2004, 49, 433-444.
[29]K. Winkler, A. L. Balch, W. Kutner, J. Solid State Electrochem. 2006, 10, 761-784.
[30]P. Pieta, E. Grodzka, K. Winkler, M. Warczak, A. Sadkowski, G. Z. Zukowska, G. M. Venukadasula, F. D'Souza, W. Kutner, J. Phys. Chem. B 2009, 113, 6682-6691.
[31]M. D. Levi, D. Aurbach, J. Power Sources 2008, 180, 902-908.
[32]M. D. Levi, A. S. Fisyuk, R. Demadrille, E. Markevich, Y. Gofer, D. Aurbach, A. Pron, Chem. Commun. 2006, 3299.
[33]P. Tang, Y. Zhao, C. Xu, K. Ni, J. Solid State Electrochem. 2013, 17, 1701-1710.
[34]X. Zhao, L. Zhang, S. Murali, M. D. Stoller, Q. Zhang, Y. Zhu, R. S. Ruoff, ACS Nano 2012, 6, 5404-5412.
[35]J. H. Kim, J. W. Lee, U. S. Shin, J. Y. Lee, S.-G. Lee, C. E. Song, Chem. Commun. 2007, 4683.

1. A method for preparing a composite material comprising electrically conductive material, the method comprising electrochemically polymerizing a fullerene or fullerene derivative on a current collector wherein the fullerene or fullerene derivative has from 1 to 84, or 1 to 70, or 1 to 60, from 1 to 20, from 1 to 18, from one to ten, or from one to six, or from one to five, or from one to three substituents each covalently bonded to one or two carbons of the fullerene spheroid.

2. (canceled)

3. The method of claim 1, wherein each said substituent is [6,6]-phenyl-C61-butyric acid methyl ester, or the fullerene derivative is selected from the group consisting of 1′,1″,4′,4″-tetrahydro-di[1,4]methanonaphthaleno[1,2:2′,3′,56,60:2″,3″ ][5,6]fullerene-C61, bis(1-[3-(methoxycarbonyl)propyl]-1-phenyl)-[6.6]C₆₂, 1′,4′-dihydro-naphtho[2′,3′:1,2][5,6]fullerene-C₆₀, (1,2-methanofullerene C₆₀)-61-carboxylic acid, 3′H-cyclopropa[8,25][5,6]fullerene-C₇₀-D₅h(6)-3′butanoic acid, 1-(3-octoxycarbonylpropyl)-1-phenyl-[6.6]C₆₁, C₆₀ pyrrolidine tris-acid, and C₆₀ pyrrolidine tris-acid ethyl ester.

4. The method of claim 1, wherein the fullerene or fullerene derivative is C₆₀ or a higher fullerene.

5. (canceled)

6. (canceled)

7. The method of claim 4, wherein the fullerene or fullerene derivative is a C₆₀ fullerene or fullerene derivative.

8. The method of claim 1, wherein the deposition comprises electrochemically oxidizing the fullerene or fullerene derivative in the presence of a tetraalkyl ammonium hexafluoroantimonate (TAASbF₆) salt.

9. The method of claim 8, wherein each of the alkyl groups of the TAASbF₆ is selected from the group consisting of methyl, ethyl, propyl (n-propyl), isopropyl, butyl (n-butyl), sec-butyl, t-butyl, pentyl (n-pentyl), neopentyl, isopentyl, hexyl, n-hexyl and any combination thereof.

10. The method of claim 9, wherein said TAASbF₆ salt is tetrabutyl ammonium hexafluoroantimonate (TBASbF₆) salt.

11. The method of claim 1, wherein the oxidizing is conducted using cyclic voltammetry under inert conditions and at ambient temperature.

12. (canceled)

13. A composite material comprising polyfullerene electrochemically deposited on a substrate wherein the substrate is a current collector.

14. (canceled)

15. The material of claim 13, wherein the polyfullerene is the product of a homopolymerization of a fullerene or a fullerene derivative wherein the fullerene or fullerene derivative has from 1 to 84, or 1 to 70, or 1 to 60, from 1 to 20, from 1 to 18, from one to ten, or from one to six, or from one to five, or from one to three substituents each covalently bonded to one or two carbons of the fullerene spheroid, and wherein each said substituent is [6,6]-phenyl-C61-butyric acid methyl ester, or the fullerene derivative is selected from the group consisting of 1′,1 “,4′,4″-tetrahydro-di[1,4]methanonaphthaleno [1,2:2′,3′,56,60:2”,3″][5,6]fullerene-C61, bis(1-[3-(methoxycarbonyl)propyl]-1-phenyl)-[6.6]C62, 1′,4′-dihydro-naphtho[2′,3′:1,21][5,6]fullerene-C60, (1,2-methanofullerene C60)-61-carboxylic acid, 3′H-cyclopropa[8,25][5,6]fullerene-C70-D5h(6)-3′butanoic acid, 1-(3-octoxycarbonylpropyl)-1-phenyl-[6.6]C61, C60 pyrrolidine tris-acid, and C60 pyrrolidine tris-acid ethyl ester.

16. The material of claim 13, wherein the polyfullerene comprises a branched polymer of C₆₀ or higher fullerene monomeric units.

17. The material of claim 16, wherein the polyfullerene is doped with TBASbF₆.

18-20. (canceled)

21. The material of claim 13 where the polyfullerene has a capacitance of at least 164 F cm⁻³ and stores multiple charges per monomer unit.

22. A supercapacitor cell comprising a negative-charge accepting electrode and a positive-charge accepting electrode, each electrode covering a current collector, an electrically insulating membrane separating the electrodes from each other, and an ionic electrolyte in which the electrodes are submerged, wherein the negative-charge accepting electrode comprises an n-doped polyfullerene porous to the electrolyte.

23. The supercapacitor of claim 22 wherein the positive-charge accepting electrode comprises a p-doped poly(3,4-ethylenedioxythiophene) (PEDOT).

24. The supercapacitor of claim 22, wherein the polyfullerene is electrochemically deposited on the current collector it covers.

25. The supercapacitor of claim 22 wherein the polyfullerene comprises a branched polymer of C60 or higher fullerene monomeric units.

26. The supercapacitor of claim 22, wherein the capacitor has a maximum power density of at least 4270 kW L⁻¹ and/or an energy density of at least 2.58 Wh L⁻¹ at 0.1 mA cm⁻².

27. The supercapacitor of claim 22, wherein the negative-charge accepting electrode and its current collector are directly bound to each other without a separate binder.

28. A porous electrode suitable for use as a component of a supercapacitor cell by being submerged in an aqueous electrolyte, wherein the electrode comprises polyfullerene, poly(3,4-ethylenedioxythiophene) (PEDOT) doped with a TBASbF₆ electrolyte and covers a metallic, conductive carbon, or conductive metal oxide current collector of the electrode, and wherein the polyfullerene is electrodeposited on said current collector to a thickness of between 1 and 100000 nm.

29-30. (canceled)
